(19) United States
(12) Patent Application Publication
(10) Pub. No.: US 2003/0185519 A1
(43) Pub. Date: Oct. 2, 2003

(54) Articulated enclosure for optical packages and method of manufacture

(76) Inventor: Michael Ushinsky, Irvine, CA (US)

Correspondence Address: CORNING INCORPORATED, SP-TI-3-1, CORNING, NY, 14831

(21) Appl. No.: 10/115,461

(22) Filed: Apr. 2, 2002

(51) Int. Cl. G02B 6/38

(52) U.S. Cl. 385/72; 385/73; 385/60

(57) ABSTRACT

An articulated enclosure for an optical package comprises toro-spherical portions which form adjustable joints. Preferably the enclosure comprises two parts, each part comprising a cylindrical portion coupled to a toro-spherical portion. The toro-spherical portion includes several meridianal cuts to allow flexibility to the toro-spherical portions and permit one toro-spherical portion to overlap the other toro-spherical portion. Optical elements and subassemblies such as fiber ferrules and collimating lenses are affixed inside the cylindrical portions. The coupled toro-spherical portions form an adjustable joint which allows movement in three degrees of freedom and permits precision alignment of the internal optical components. The tension in the adjustable joint holds the alignment temporarily while the joint is secured with either solder or adhesive. The articulated enclosure permits optical alignment of the subassemblies and improved thermal protection.

### BACKGROUND OF THE INVENTION

1. Field of the Invention

The present invention relates generally to 2-, 3-, and multi-port optical packages and, in particular to an enclosure for optical packages.

2. Technical Background

There is considerable interest in the field of optics, particularly relating to the area of telecommunication systems. Optical fibers are the transmission medium of choice for handling the large volume of voice, video, and data signals that are communicated over both long distances and local networks. Much of the interest in this area has been spurred by the significant increase in communications traffic which is due, at least in part, to the Internet. Important elements of fiber optic networks are the optical filters, optical isolators, circulators, and similar devices which modify, shape, direct, and block light signals. In addition, these devices may be subjected to various thermal and mechanical loads during production and in operation. Since virtually all light signals are transmitted through these devices, it is critical to the operation of the network that these devices function reliably over their projected 20-25 year service life. Further, these devices represent a significant portion of the cost of a network. Therefore, it is desirable to reduce the cost of these important components.

An example of the prior art is illustrated in a cross section view of a 3-port filter package in FIG. 1. A brief description of the function of the package is as follows. A light signal 11a enters input optical fiber 12a which is adhesively bonded in a capillary of glass ferrule 13a. The signal 11a exits fiber 12a and travels through input collimating lens 14a where the signal is directed to a thin film filter 15 which is deposited on a glass substrate. Filter 15 typically attached to lens 14 splits the light signal 11a by transmitting certain wavelengths of signal 11a and also reflecting certain wavelengths of signal 11a. The transmitted signal 11b travels through the output collimating lens 14b where the signal is directed to the output fiber 12b that is positioned in a capillary of ferrule 13b. The reflected signal 11c travels back through input collimating lens 14a and is directed to reflected fiber 12c.

The remaining parts of the package 10 include insulating glass sleeves 16a and 16b, cylindrical metal housings 17a and 17b, and protective outer metal sleeve18. The ferrules 13a and 13b and collimating lenses 14a and 14b are housed inside glass sleeves 16 and the three components together are referred to as collimating assemblies. The glass sleeves 16 are inserted inside of metal housings 17 which provide additional protection. Adhesive is used extensively to secure the filter 15 to collimating lens 14a, to secure ferrules 13 and lenses 14 inside glass sleeves 16, and to secure glass sleeves 16 inside metal housings 17. Finally, both the aligned collimating assemblies that are protected with metal housings 17 are secured inside protective metal sleeve 18 via low temperature solder 19. The diameter of the interior of protective metal sleeve 18 is slightly larger than the outer diameter of metal housings 17 so that the collimating assemblies may be tilted or repositioned slightly, generally less than 5° and preferably less than 2°, to optically align the two interrelated collimating assemblies. Soldering of these non-capillary gaps, however, meets well known difficulties such as high volume shrinkage of the solder, void formation, contamination of optical components, etc.

While these packages can function well, there are some aspects which can be improved upon. These include cost, performance, and reliability. The package enclosure, which is formed from six to eight telescopically positioned protective sleeves or housings, typically has micron or even sub-micron transverse tolerances. Maintaining these tolerances requires precision machining and alignment operations, which result in high equipment and labor costs, reduced yield, time-consuming alignment, and soldering with frequent rework. Some of the expense is due, at least in part, to damage caused by the close proximity of hot solder and flux to heat sensitive adhesive and optical components. For example, the cost of a single damaged filter may be significant. The irreversible displacement in optical components due to thermal stress or solder contamination may affect both the insertion loss level and the spectral performance of a filter. As a consequence of these limitations, the acceptable optical performance may be allowed to degrade so that the alignment and manufacturing tolerance can be loosened and costs reduced. A device, system, or method to reduce the risk of damage to components, increase yield, reduce manufacturing costs, simplify manufacturing, and improve performance would be a significant advantage.

Finally, any package design should be adequate not only to mechanically protect the fragile optical components but also to compensate for and minimize the thermally induced shift in spectral performance.

The continuing goal, therefore, is to find ways to reduce costs and improve quality and performance of enclosures for optical devices. It is also a goal to design an enclosure that is simple in construction and miniaturized.

### SUMMARY OF THE INVENTION

To address the goals stated above, the invention discloses an optical package that increases optical performance and reduces costs. The invention achieves these goals by means of an articulated protective enclosure that covers, for example, the collimating assembly portions of an optical package and allows the components to be optically aligned by manipulation of the joint in the articulated protective enclosure. The invention eliminates the need for precision alignment and bonding of the collimating assemblies into a non-articulating metal sleeve, simplifies alignment, is easy to manufacture, increases performance, and reduces costs.

The invention preferably realizes these advantages using a new design for an enclosure that comprises two pieces or units. Each piece comprises a cylindrical portion and a toro-spherical portion with several meridianal cuts (slots) by which the two pieces are coupled together and form a movable joint. The joint permits the internal optical components to be aligned after they have been affixed inside of the enclosure. Using this design the components are affixed inside the enclosure without concern for maintaining an optical alignment. This simplifies manufacturing since the precise optical alignment is easily accomplished in a later step via manipulation of the joint.

The soldered or welded joint is removed from the optically sensitive filter and collimating assemblies, and therefore, the invention achieves improved yield since the precision optical alignment is not easily disturbed by stress from either thermal expansion and contraction or from adhesive curing. Moreover, the alignment step involving the input and output collimating assemblies is done only after these high stress steps are completed. Further, the toro-spherical portions are easily manufactured, inexpensive, and do not require expensive new machinery or training.

The joint is temporarily held in position due to the spring tension that the thin-walled toro-spherical portions exert against each other. The spring tension comes from slots or cuts in the thin-walled toro-spherical portion. One or both of the mated toro-spherical portions include meridianal cuts or slots that allow the toro-spherical portions to either expand or contract under force and therefore permit two toro-spherical portions to be assembled into a ball joint formed from the over lapping toro-spherical portions. The meridianal cuts cause the resulting toro-spherical portion to function as multiple torsion springs and hold the joint in place until the aligned joint is either soldered, welded, or bonded with adhesive. Soldering is normally a high-risk operation because of the close proximity of the fragile optical components to hot solder or flux. The temperature from soldering can induce stress that can either damage or misalign the optical components. In addition, the close proximity of solder can contaminate the optical components or otherwise block the optical path. The invention reduces this threat since the soldering of the joint is farther away from optical components and therefor significantly reduces the risk of heat stress and contamination.

For additional protection the articulated enclosure is coated with a moisture resistant coating and encased inside heat shrink tubing.

It is clear that the invention is a significant improvement over the prior art. Further, those skilled in the art recognized that the invention is not limited to use with optical filters. Other optical devices may also be used in the invention. Various types of articulated enclosures may be used to practice the invention.

It is to be understood that the foregoing description is exemplary of the invention only and is intended to provide an overview for the understanding of the nature and character of the invention as it is defined by the claims. The accompanying drawings are included to provide a further understanding of the invention and are incorporated and constitute part of this specification. The drawings illustrate various features and embodiments of the invention which, together with their description serve to explain the principals and operation of the invention.

### BRIEF DESCRIPTION OF THE DRAWINGS

FIG. 1 is a cross-section view of a prior art filter package;

FIG. 2A is a schematic diagram of one embodiment of the invention;

FIG. 2B is a schematic diagram of one embodiment encased in gel coating and shrink tubing;

FIG. 3 is a cross-section view of the preferred embodiment of the invention;

FIG. 4 illustrates the articulated movement of the enclosure that provides the alignment; and

FIGS. 5A and 5B illustrate two alternate embodiments of articulated enclosures according to the invention.

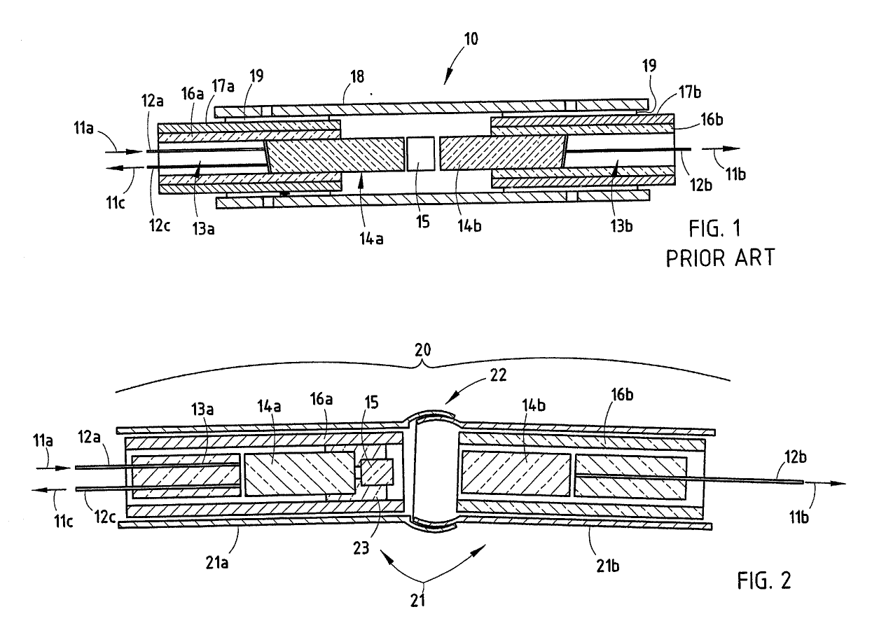

### DETAILED DESCRIPTION OF THE PREFERRED EMBODIMENT

The invention will first be described referring to a schematic diagram and then referring to a cross-section view of the preferred embodiment. The preferred use for the invention is as an enclosure for optical components in a telecommunications network and therefore the following discussion will describe the invention in relation to such applications.

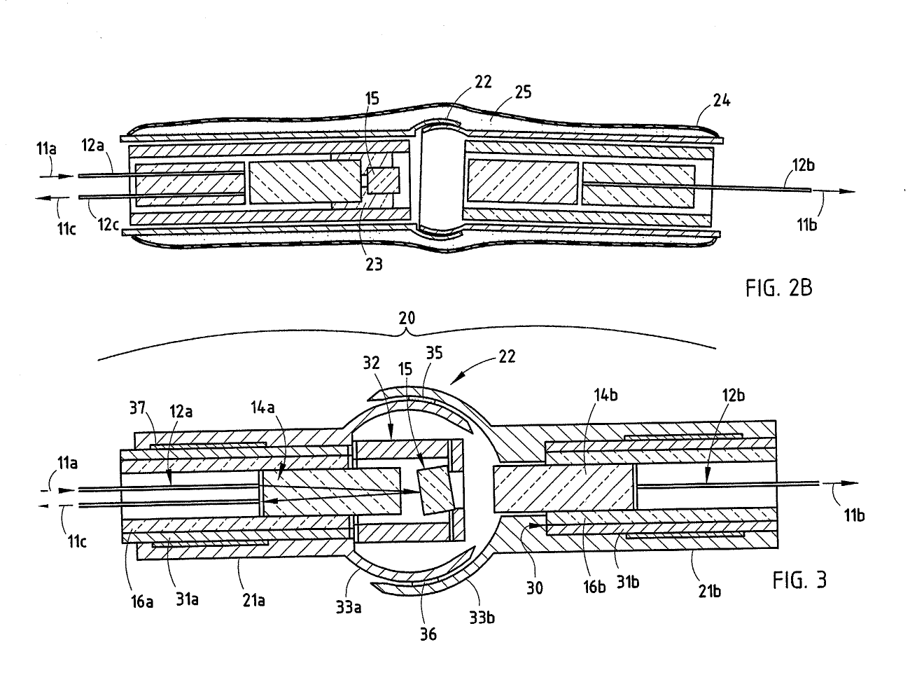

Referring first to FIG. 2A there is shown a schematic diagram of the invention. In this illustration there is one input optical fiber 12a, one output optical fiber 12b, one reflected optical fiber 12c, and an optical component (e.g. filter) 15. Those skilled in the art will recognize that the inventive enclosure is equally applicable to multi-port packages comprising multiple input and output fibers and various other types of optical components. The functionality of the internal optical components is substantially the same as in the prior art and is described briefly.

A light signal 11a enters the package 20 through input optical fiber 12a. Light signal 11a is preferably a conventional optical signal having wavelengths in the C-band or possibly in the S-band or L-band and is also a wavelength division multiplexed (WDM) signal. Optical fibers 12 are conventional optical fibers commonly used in telecommunications applications and may be either multi-mode or single-mode fibers depending on the application. Fibers 12 are stripped of their polymer coating and bonded inside the capillaries of input ferrule 13a and output ferrule 13b in a conventional manner.

Light signal 11a exits input fiber 12a and enters input collimating lens 14a which directs the light beams to optical filter 15. Lens 14a is preferably a graded index (GRIN) collimating lens but may be another type of lens such as a ball lens collimator. Light signal 11a is spectrally modified by filter 15 and transmitted to output collimating lens 14b. Output lens 14b collimates the modified light signal 11b to output fiber 12b which guides the modified signal 11b out of the package 20. A portion of light signal 11a is reflected by filter 15 and transmitted through input collimating lens 14a collimates the reflected light signal 11c to reflected fiber 12c.

In this schematic the input ferrule 13a, reflected fiber 12c, and input fiber 12a are together referred to as the input ferrule subassembly. Similarly, the output ferrule 13b and output fiber 12b are together referred to as the output ferrule subassembly. Each of the ferrules 13 are secured inside of an insulating or protective glass sleeve 16a and 16b. A unit comprising a ferrule 13 and collimating lens 14 secured inside of an insulating sleeve 16 is referred to a collimating subassembly. When an optical filter 15 is attached the unit is referred to as a filter assembly. Filter 15 is attached to the input collimating leans 14a via filter holder 23. The inventive enclosure 21 will now be described.

Articulated enclosure 21 comprises two protective sleeves 21a and 21b. Each protective sleeve 21a and 21b comprises a hollow cylindrical portion for enclosing a collimating assembly and a toro-spherical portion for coupling with the opposing toro-spherical portion to form a ball joint 22. Ball joint 22 allows the enclosure 21 to move in three rotational degrees of freedom and thereby optically align the fibers 11 to minimize insertion loss. The assemblies inserted inside the enclosure units also have an additional degree of freedom in the longitudinal direction to optimize performance. A benefit of enclosure 21 is that the toro-spherical portions are fit together tightly and under spring tension such that the optical alignment is temporarily maintained until the ball joint 22 is permanently secured with solder or adhesive. Dimensional parameters of these portions and slots can be suggested to optimize this spring effect.

In one aspect of the invention, a moisture resistant coating (gel) 25 and shrinkable polymer tubing 24 as illustrated in FIG. 2B protect the articulated enclosure. Gel 25 provides reduces shock to the package 20 and shrink tubing 24 provides protection and holds the gel 25 in place. Gel 25 preferably fills any gaps between tubing 24 and enclosure 21. Heat is applied to shrink tubing 24 until the tubing 24 fits tightly around gel 25 and enclosure 21. Gel 25 is then cured, preferably with either heat or UV light. A cross section of the invention is described next. A cross section of the invention is described next.

Another embodiment of the invention is shown in FIG. 3 with enclosure 21 having an alternative shape and the internal optical components positioned differently. FIG. 3 illustrates optical fibers 12, ferrules 13, collimating lenses 14, and insulating sleeves 16 secured inside of enclosure 21. These components function similar to those in FIG. 2. However, there are several differences over the embodiment in FIG. 2. The sleeves 21a and 21b each comprise a ridge 30 to stop the insulating sleeves 16 and housing 31 at a desired insertion point. This may be useful in applications where a precise distance between the optical components is desired.

Another aspect of this embodiment is a filter holder 32 supports filter 15. Filter holder 32 may be made of either glass or metal and is bonded to either sleeve 21a or collimating lens 14a with adhesive. This embodiment permits precise positioning of filter 15 relative to the collimating lenses 14 and also positions filter 15 inside of ball joint 22 so that the filter is near the axis of rotation of joint 22.

Ball joint 22 comprises the overlapping toro-spherical portions 33a and 33b of sleeves 21a and 21b. The toro-spherical portions 33 preferably fit tightly together under spring tension such that the position of joint 22 maintains the optical alignment. In this manner the enclosure 20 will maintain an optical alignment until the ball joint 22 is secured in place with either solder 35 or adhesive 36. Typically only solder 35 or only adhesive 36 is used. They are both shown in the figure for illustrative purposes only.

One aspect of the invention is the separation distance between the optical components (e.g., filter and collimator) and the solder 35. The increased distance reduces the chance of solder contaminating the optical components and similarly reduces detrimental thermal stresses associated with soldering.

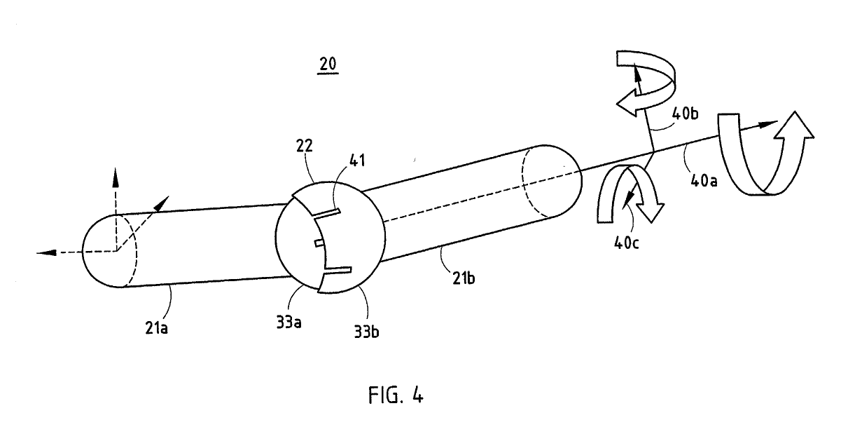

The articulated movement of enclosure 21 is illustrated in FIG. 4. Two sleeve portions 21a and 21b are shown with their toro-spherical portions coupled together in ball joint 22. The sleeve portions 21 may be moved in three degrees of freedom as illustrated by the three axes 40a, 40b, and 40c and the associated arrows. Each sleeve portion 21 can be moved vertically, horizontally, and rotated to achieve a desired alignment of the optical components. The angle between the sleeve portions 21 is exaggerated for illustrative purposes. Normally optical alignment requires less than a three-degree relative angle between the sleeve portions 21. It should be noted, however, that ball joint 22 does allow much larger movement of the sleeve portions 21 if it is required for a particular application.

Another aspect of the invention is the cuts or slots 41 in the toro-spherical portions 33a and 33b. Slots 41 permit the toro-spherical portions 33a and 33b to flex similar to a leaf spring and thereby facilitate coupling the toro-spherical portions 33a and 33b together in an overlapping fashion. The preferred embodiment has between three and six slots equally spaced around the circumference of each toro-spherical portion 33 to provide adequate spring tension and flexibility. Spring flexibility is a function of the number of slots 41, the length and width of the slots 41, and the curvature radii of the toro-spherical portion 33. These parameters can be optimized to satisfy the requirements of a particular application. The tension from the flexing toro-spherical portions 33 hold the ball joint 22 snugly in position. The package is then optically aligned and the ball joint 22 maintains the desired alignment until the ball joint 22 is permanently secured with either solder or adhesive.

Slots 41 are also useful as the grooves in applying the solder or adhesive to ball joint 22. The solder or adhesive is applied to the slots 41 and is drawn into gaps or capillaries between the toro-spherical portions 33 to form a strong joint.

The adhesive for securing the filter, and filter holder should be thermally matched as closely as possible with the materials being bonded. A low-shrinkable and high-modulus adhesive, such as EMI 3410, with a coefficient of thermal expansion matching adherent glass and metal components may be used to minimize the mismatched stresses in these bonds. This is applicable, for example, when bonding a metal filter holder with the glass filter and glass lens. An alternative method of mounting the filter is to eliminate the filter holder and bond the filter 15 directly to the end face of the lens 14 with a thin layer of optically transparent adhesive applied over the entire end face of the lens 14 or apply the adhesive only to the circumference of the end face. Using such a circumferential bond has the advantage of having no adhesive in the path. Instead, the adhesive is present only around the circumference of the end face of lens 14. For the circumferential bond a high viscosity adhesive is preferred to prevent the adhesive from spreading. A viscosity of between 15,000 cps to 60,000 cps is preferred A suitable adhesive is EPO-TEK 353NDT or 353ND-4 manufactured by Epoxy Technology, Inc. of Billerica, Mass.

Low-temperature solder is the preferred method to solder the metal sleeves 31 to the interior of the metal enclosure 21. The assembled ferrule 13, lens 14, insulating glass tube 16, and metal housing 31 experience residual thermal stresses due to the contraction mismatch of the materials and adhesives used. In order to minimize and maintain these stresses, a high compliance bond is suggested and an RTV silicone adhesive, such as DC 577, may be used. The length of the solder pool 37 is preferably limited to approximately 50% of the length of the metal housing 31. This prevents contamination of the filter and minimizes repositioning of the lens 14 and filter 15 due to thermal stresses. Several alternate embodiments of the invention are envisioned and some are illustrated next.

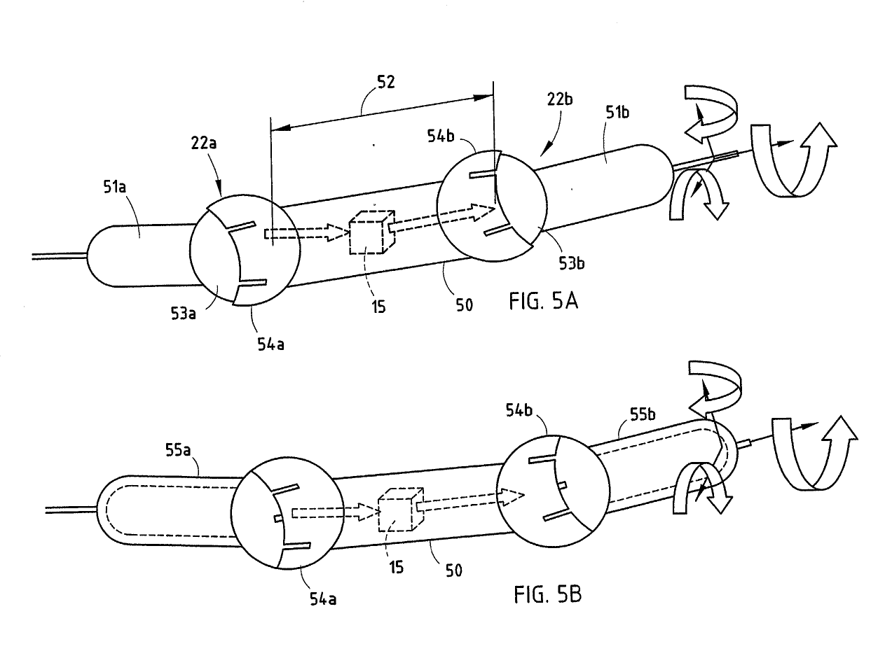

Referring now to FIGS. 5A and 5B there are illustrated two alternate embodiments of the invention. FIG. 5A shows an embodiment with a single sleeve portion 50 and FIG. 5B shows an embodiment with three sleeve portions 50, 55a and 55b.

The one-sleeve design of FIG. 5A comprises a single sleeve portion 50 that couples to two collimating assemblies 51. Each collimating assemble 51 comprises a spherical collimating lens 53a and 53b which is held tightly inside the toro-spherical portions 54a and 54b of sleeve 50. The optical device or filter 15 is secured inside of sleeve 50 with a filter holder (not shown). A filter holder may be of the type similar to holder 23 shown in FIG. 2. One aspect of this design is the distance 52 between the ball lens collimators 53. This distance can be precisely controlled such that light transmitted between the ball lenses is extremely collimated. Also, there are two articulating or ball joints 22a and 22b that allow alignment of both collimating assemblies 51 relative to filter 15. One consequence of this design is that the enclosure does not protect all parts of the collimating assemblies 51. Improved protection is provided by the three-sleeve design of FIG. 5B.

The three-sleeve design shown in FIG. 5B is similar to the one-sleeve design of FIG. 5A except that the middle sleeve portion 50 is coupled to two sleeve portions 55a and 55b instead of ball lenses 53. The three-sleeve design has the advantage of two movable ball joints 22 and also provides improved protection for the collimating assemblies 53.

In addition to the previously mentioned advantages, the enclosure materials used in the invention are inexpensive, the thermo-mechanical behavior of the materials are well understood and are predictable. Finally, the package enclosure does not require high precision machining.

The method of the invention follows from the apparatus description. At least one protective sleeve comprising a toro-spherical portion is interposed between two fiber ferrules. Each of the fiber ferrules comprises an optical fiber bonded inside a capillary in each ferrule. The optical fibers in opposing ferrules are optically coupled to one another through the cylindrical protective sleeve that is mechanically coupled to the ferrules. The toro-spherical portion of the protective sleeves forms an articulating joint by which the two ferrules are tilted and rotated and assemblies can also be axially protruded (i.e., change focal distance) relative to one another to achieve optical alignment. The articulating joint is then fixed in position by either soldering or adhesively bonding the joint. The package is next encased in gel and covered in shrinkable material. The gel preferably is a silicone gel that cures to a moisture resistant material and the shrinkable material is preferably heat shrinkable tubing.

A one-sleeve enclosure comprises a cylindrical and two toro-spherical portions, one on each end of the cylindrical portion. The spherically shaped portion of the collimating lenses are inserted inside of the toro-spherical portions form articulating ball joints. The toro-spherical portions are provided with several meridianal slots that permit the toro-spherical portions to expand and facilitate insertion of the lens. The collimating assemblies and the one-piece enclosure are thus assembled into a package comprising two ball joints. The collimating assemblies are tilted and rotated to optically align the package to achieve a filtering or alignment target. The joint is bonded using ultra-violet tacking adhesive or low temperature solder.

In the case of a three-sleeve enclosure, the two end-pieces are each comprised of a cylindrical portion and a toro-spherical portion and a middle-sleeve comprises a cylindrical portion and two toro-spherical portions similar to the one-piece enclosure described above. The internal optical components are secured inside of the three pieces. One collimating assembly is secured inside each end-sleeve. The toro-spherical portions of these three pieces are then assembled to create a three-piece enclosure with two ball joints. The enclosure is then optically aligned to a predetermined filtering or insertion loss target and either bonded or soldered.

The preferred two-sleeve embodiment comprises two sleeves, each sleeve comprising a cylindrical portion and a toro-spherical portion. They are assembled, aligned, and bonded in a fashion similar to the one-piece and three-piece embodiments.

It will become apparent to those skilled in the art that various modifications to the preferred embodiment of the invention as described herein can be made without departing from the spirit or scope of the invention as defined by the appended claims.

The invention claimed is:

1. An optical package comprising:
an input ferrule comprising at least one capillary extending axially through the ferrule;
at least one input optical fiber inserted in the capillary;
an output ferrule comprising at least one capillary extending axially through the output ferrule;
at least one output fiber inserted in the capillary of the output ferrule;
an enclosure comprising a first and a second protective sleeves, each sleeve comprising a cylindrical portion coupled to a toro-spherical portion, the first protective sleeve enclosing the input ferrule and the second protective sleeve enclosing the output ferrule; and
wherein the toro-spherical portions of the protective sleeves are coupled to form an adjustable joint.

2. The optical package of claim 1 wherein at least one of the toro-spherical portions comprises a plurality of meridianal cuts.

3. The optical package of claim 1 wherein the input fiber and the output fiber are optically aligned by moving the adjustable joint.

4. The optical package of claim 1 further comprising,
an input collimating lens positioned in the first protective sleeve to receive a light signal emitted from the input fiber;
an output collimating lens positioned in the second protective sleeve to transmit the light signal to the output fiber; and
wherein the input collimating lens and the output collimating lens are optically aligned to transmit the light signal from the input fiber to the output fiber via movement of the adjustable joint.

5. The optical package of claim 1 further comprising:
a moisture resistant gel applied to the exterior of the enclosure; and
a shrink tubing surrounding the moisture resistant gel.

6. A method for optically aligning the components of an optical package comprising the steps of:
providing a protective sleeve comprising a channel portion coupled to a toro-spherical portion;
providing a first ferrule comprising a first optical fiber extending axially through the ferrule;
providing a second ferrule comprising a second output fiber extending axially through the second ferrule;
positioning at least a portion of the first ferrule inside the channel portion;
optically coupling the first and second fibers through the protective sleeve; and
wherein the toro-spherical portion forms part of an adjustable joint.

7. The method of claim 6 further comprising the step of optically aligning the first fiber and the second fiber via movement of the adjustable joint.

8. The method of claim 7 wherein the step of optically aligning includes changing the angle of the first fiber relative to the second fiber by way of the adjustable joint.

9. The method of claim 8 wherein the step of optically aligning includes changing the angle horizontally.

10. The method of claim 8 wherein the step of optical aligning includes changing the angle vertically.

11. The method of claim 7 wherein the step of optical aligning includes rotating the first and second ferrules relative to one another via the adjustable joint.

12. The method of claim 6 wherein the toro-spherical portion comprises at least one meridianal cut.

13. The method of claim 6 further comprising the step of soldering the adjustable joint to a fixed position.

14. The method of claim 6 further comprising the step of applying and curing an adhesive to the adjustable joint.

15. A method for enclosing an optical subassembly comprising the steps of:
providing a protective sleeve comprising a toro-spherical portion;
providing a first collimating assembly comprising a toro-spherical portion;
coupling the toro-spherical portion of the first collimating assembly with the toro-spherical portion of the protective sleeve forming an adjustable joint;
providing a second collimating assembly; and
optically coupling the first collimating assembly with the second collimating assembly through the protective sleeve.

16. The method of claim 15 wherein the first collimating assembly comprises a ball lens.

17. The method of claim 15 further comprising the steps of:
providing tubing material comprising a capillary portion sufficiently large to receive the sleeve; and
inserting the sleeve into the capillary of the tubing.

18. The method of claim 17 wherein the tubing material is a thermally shrinking material.

19. The method of claim 17 further comprising the steps of:
providing a sealant material; and
placing the sealant material in the gaps between the sleeve and the tubing.

20. The method of claim 15 further comprising the steps of:
providing an optical element; and
interposing the optical element between the first collimating assembly and the second collimating assembly.

21. The method of claim 20 further comprising the step of optically aligning the input collimating assembly, the optical element, and the output collimating assembly via movement of the first and second adjustable joints.

22. The method of claim 15 further comprising the step of optically aligning the first collimating assembly with the second collimating assembly.

23. The method of claim 22 wherein the step of optically aligning comprises adjusting the adjustable joint.

24. The method of claim 23 further comprising the step of fixing the position of the adjustable joint.

25. The method of claim 24 wherein the step of fixing comprises soldering the adjustable joint.

26. The method of claim 24 wherein the step of fixing comprises adhesively bonding the adjustable joint.

27. The method of claim 15 wherein the toro-spherical portion comprises at least one meridianal slot.
